(19) United States
(12) Patent Application Publication
(10) Pub. No.: US 2013/0340946 A1
(43) Pub. Date: Dec. 26, 2013

(54) LABELER

(71) Applicant: Multivac Marking & Inspection GmbH & Co. KG, Enger (DE)

(72) Inventors: Hendrik Frank, Enger (DE); Daniel Siegenbrink, Bielefeld (DE); Georg Austermeier, Hovelhof (DE); Markus Dauwe, Hilter (DE)

(21) Appl. No.: 13/926,929

(22) Filed: Jun. 25, 2013

(30) Foreign Application Priority Data
Jun. 26, 2012 (EP) 12004769.1

(51) Int. Cl. B65C 9/18

(52) U.S. Cl. CPC B65C 9/1869
USPC 156/540; 156/538

(57) ABSTRACT

The invention relates to a labeler. The labeler comprises a dispenser and a transfer unit having at least one label conveyor belt for applying a label to a product, the label conveyor belt having an adhesive force so as to be able to take up labels with their non-adhesive upper surface on the surface of the label conveyor belt and convey them.

### CROSS-REFERENCE TO RELATED APPLICATIONS

This Application claims priority to European Application Number 12004769.1 filed Jun. 26, 2012, to Hendrik Frank, Daniel Siegenbrink, Georg Austermeier and Markus Dauwe entitled “Labeler,” currently pending, the entire disclosure of which is incorporated herein by reference.

### FIELD OF THE INVENTION

The invention relates to a labeler.

### BACKGROUND OF THE INVENTION

WO 03/099951 A2 discloses a microstructured surface with increased adherence comprising a plurality of elastic projections. According to the so-called van der Waals interaction, this surface adheres to other objects. DE 10 2010 044 660 A1 discloses an improved embodiment of projections, which enhances the adhesion and separation properties still further. However, none of these two documents is related to labeling technology in any way.

DE 10 228 243 A1, which is owned by the applicant himself, discloses a cross-web labeler with a suction box including at least one fan, which provides for a partial vacuum at the label conveyor belt so as to be able to hold labels with their non-adhesive upper surface on the lower surface of the label conveyor belt during transport. Fans are not always advantageous from the hygienic point of view.

DE 10 2007 033 628 A1, which is also owned by the applicant, discloses a labeler for applying a set of labels, which are dispensed, in a multi-row and multi-lane mode, from a transfer belt provided with a silicone coating, so as to apply, for example, the set of labels to packages in a thermoform packaging machine while said labels are being advanced. The labels are here in contact with the transfer belt with their adhesive side. Due to the different adhesive forces and the continuously varying degree of contamination of the silicone coating of the transfer belt, the adhesive conditions vary continuously and this has a negative effect on process reliability, since the labels do not reliably adhere to the silicone coating during the conveying movement or, on the contrary, adhere more strongly than desired, so that they remain stuck to the silicone coating without being applied to the package.

### SUMMARY OF THE INVENTION

It is the object of the present invention to provide an improved labeler.

The labeler according to the present invention may comprise a dispenser and a transfer unit with at least one label conveyor belt for applying a label to a product, wherein the label conveyor belt has an adhesive force so as to be able to take up labels with their non-adhesive upper surface on the surface of the label conveyor belt and convey them. This provides the advantage of independency from different adhesive properties of the labels, and the adhesive properties will not be influenced by a contamination of the surface of the label conveyor belt caused by adhesive residues. Generating a partial vacuum in the transfer unit by means of a fan is not necessary either, whereby the design and the structure of such a transfer unit and of the labeler, respectively, are significantly simplified. The thus markedly reduced own weight of the transfer unit allows the transfer unit itself to move towards the product so as to apply and press-on the labels. The use of movable slide plates, which are known from the prior art, is in this case no longer necessary.

According to one embodiment, the adhesive force of the label conveyor belt is based on van der Waals forces, so that the non-adhesive side of a label can be conveyed on the label conveyor belt precisely in position without any vacuum being necessary. The phrase “precisely in position” means that the position of the label will not change due to forces of weight or inertia with respect to its position relative to the label conveyor belt.

A nano- or microstructured coating may be provided as surface of the label conveyor belt. A nanostructured coating in the sense of the present invention can be a coating having surface structures in a range of about 100 nm or smaller. A microstructured coating can be a coating having surface structures in a range of about 0.1 μm to about 100 μm. The respective surface structures may be heads or tips of adhesion elements, the dimensions indicated relating, for example, to the diameters or radii of curvature of the tips or heads of the adhesion elements.

The adhesive properties produced by the nano- or microstructured coating allow the labels to adhere with their adhesive as well as with their non-adhesive side. The adhesive properties also allow the labels to be conveyed on the lower surface of a lower run of the label conveyor belt, without it being necessary to hold the labels on the label conveyor belt by means of a vacuum.

The microstructured coating of the label conveyor belt can have a surface including more than 15,000 adhesion elements per cm², preferably more than 25,000 adhesion elements per cm². This embodiment is particularly suitable for making smooth surfaces adhere to the coating, such smooth surfaces existing, for example, in the case of imprinted labels on the non-adhesive top face or visible face of the labels. At the same time, the coating allows the labels to be easily removed or detached by means of peeling off at a point of deflection, since the distances between the adhesion elements change at a point of deflection and the labels get there gradually detached from the adhesion elements.

According to one embodiment, the coating is a silicone coating and is therefore easy to clean as well as flexible.

In an alternative embodiment, the adhesive force is provided on the basis of electrostatic forces between the label and the label conveyor belt. These electrostatic forces can be generated in the area of the dispensing edge or at the beginning of the label conveyor belt.

The label conveyor belt may be provided for taking up a row of labels for applying these labels in one operating step to a row of packages, for example, in a thermoform packaging machine, whereby the labeling performance (defined by the number of labels applied per unit time) is increased.

Alternatively, a special embodiment is provided, according to which a plurality of rows of labels can be transferred to the label conveyor belt so as to form a group of labels comprising a plurality of rows and a plurality of lanes, whereby the labeling performance can be increased still further. In the case of a group, a row extends, by definition, transversely and a lane longitudinally to the direction of transport of the label conveyor belt.

In accordance with a method for operating the above-described labeler, the labels are removed from the label conveyor belt in that they adhere with their adhesive lower surface to the product to be labeled.

The labels may be here removed from the label conveyor belt by means of peeling off. This is advantageous insofar as a very small diameter, which has to be used in the case of a dispensing edge, is here not necessary, but a large diameter is possible and suitable. This leads to a reduction of the mechanical load acting on the label conveyor belt.

The speed of the label conveyor belt and the speed of the product to be labeled are preferably synchronized so as to increase the positioning accuracy of the labels on the products and so as to simplify the control of the drives.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a schematic side view a labeler having a cross-web labeler in a dispensing phase according to one embodiment the present invention;

FIG. 1a is a schematic side view the labeler of FIG. 1 in its put-down phase;

FIG. 1b is a schematic side view the labeler of FIG. 1 after the put-down phase;

FIG. 2 is a schematic side view of an alternative labeler as longitudinal lane labeler according to one embodiment the present invention;

FIG. 3 is a schematic side view of a further alternative labeler for dispensing a set of labels at the beginning of the dispensing phase according to one embodiment the present invention;

FIG. 3a is a schematic side view the labeler of FIG. 3 at the end of a dispensing phase;

FIG. 3b is a schematic side view the labeler of FIG. 3 in its put-down phase;

FIG. 4 is a schematic side view of a label conveyor belt according to one embodiment of the present invention; and

FIG. 5 is an enlarged schematic representation of a cross-section of a label conveyor belt according to one embodiment of the present invention.

Identical components are provided with identical reference numerals throughout the figures.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

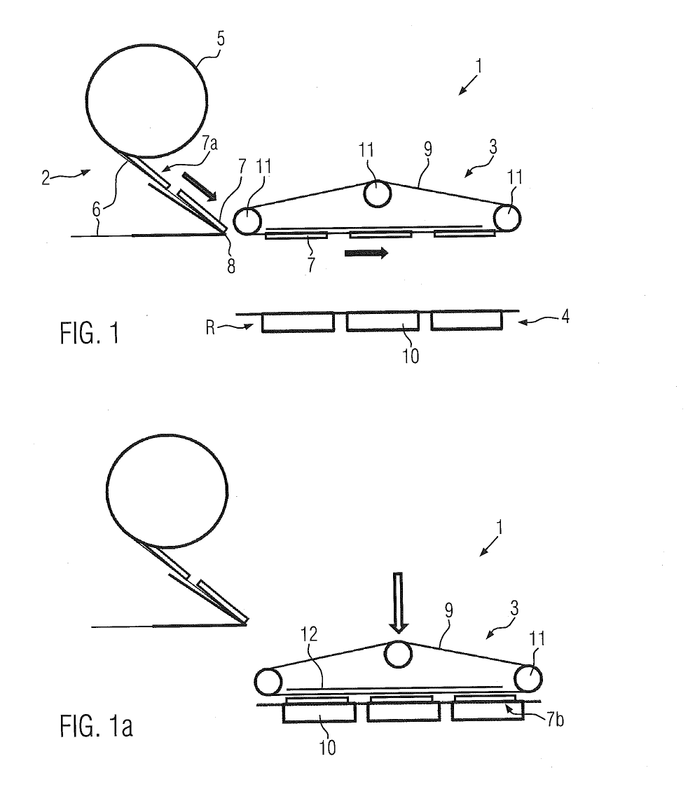

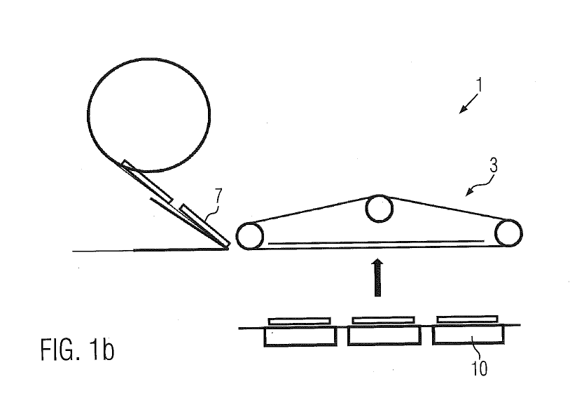

FIG. 1 schematically shows a labeler 1 according to the present invention, comprising a dispenser 2 and a label transfer unit 3 extending transversely across a package group 4 produced, for example, by a thermoform packaging machine that has a direction of transport which, in turn, extends out of the drawing plane. The dispenser 2 may include a roll 5 from which a backing strip 6 with labels 7 is pulled over a dispensing edge 8 for dispensing labels 7. The labels 7 that peel off from the backing strip 6 at the dispensing edge 8 are taken over by the label conveyor belt 9. The non-adhesive upper surface 7a of the labels 7 adheres to a nano- or microstructured coating 16 of the label conveyor belt 9, especially to the lower surface of the lower run of the label conveyor belt 9. According to the number of packages 10 to be labeled in one row R (in the present example three packages 10 or products to be labeled), three labels 7 are transferred from the dispenser 2 to the label conveyor belt 9. The label conveyor belt 9 may run around three pulleys 11, at least one of these pulleys 11 being adapted to be driven by an electric motor, which is not shown.

As shown in FIG. 1a, the label conveyor belt 9 may then move downwards in the direction of the packages 10 by means of a pneumatic drive or an electric drive, which is not shown, so as to press the three labels 7 with their adhesive lower surface 7b onto the packages 10, also referred to as product. In the course of this process, a pressure plate 12 supports the press-on operation and prevents the label conveyor belt 9 from yielding upwards. The contact pressure can thus be adjusted via the position of the transfer unit 3 (together with the pressure plate 12) or the driving power of the pneumatic drive or the electric drive.

Subsequently, the transfer unit 3 can be moved upwards to the position at which the next three labels 7 are taken up by the label conveyor belt 9 so as to label the next row R of packages 10 (cf. FIG. 1b).

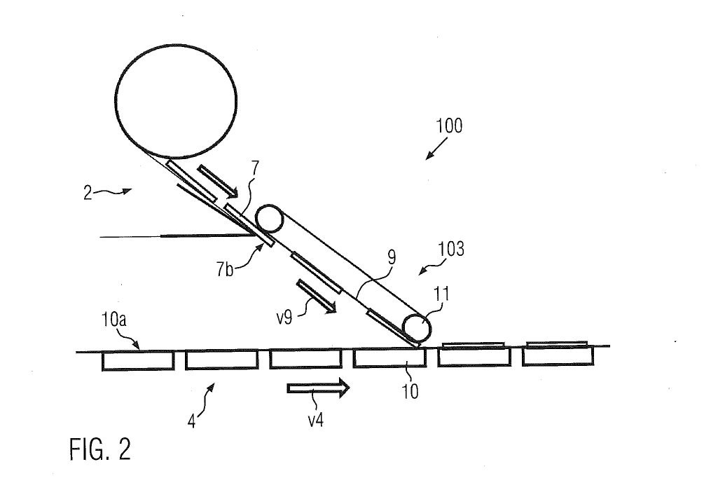

FIG. 2 shows schematically an alternative labeler 100 according to the present invention, comprising a dispenser 2 and a transfer unit 103. The transfer unit 103 may take over the labels 7 in the same way as the transfer unit 3 in FIG. 1. The transfer unit 103 can be oriented at an oblique angle downwards and configured with a lower pulley 11 such that the label 7 is caught by the package 10 in the area of the lower pulley 11, since the adhesive lower surface 7b will adhere to the upper surface 10a of the package 10. In the course of this process, the label 7 can be peeled off from the label conveyor belt 9. Other than in the case of a prior art embodiment, where the labels are conveyed with the adhesive side on the label conveyor belt and can only be removed from the label conveyor belt via a dispensing edge with a very small radius, the labeler 100 according to the present invention allows large radii of, for example, 10-20 mm, at the lower pulley 11, whereby the permanent load acting on the label conveyor belt is significantly reduced. The advance movement v9 of the label conveyor belt 9 and the advance movement v4 of the package group 4 can be carried out synchronously by means of a common control unit, which is not shown, or by means of two control units communicating with each other. A change of the distance between two neighboring labels 7 in the direction of transport can take place during transfer from the dispenser 2 to the label conveyor belt 9 or between the processes in which neighboring labels 7 are peeled off from the label conveyor belt 9 by the package 10.

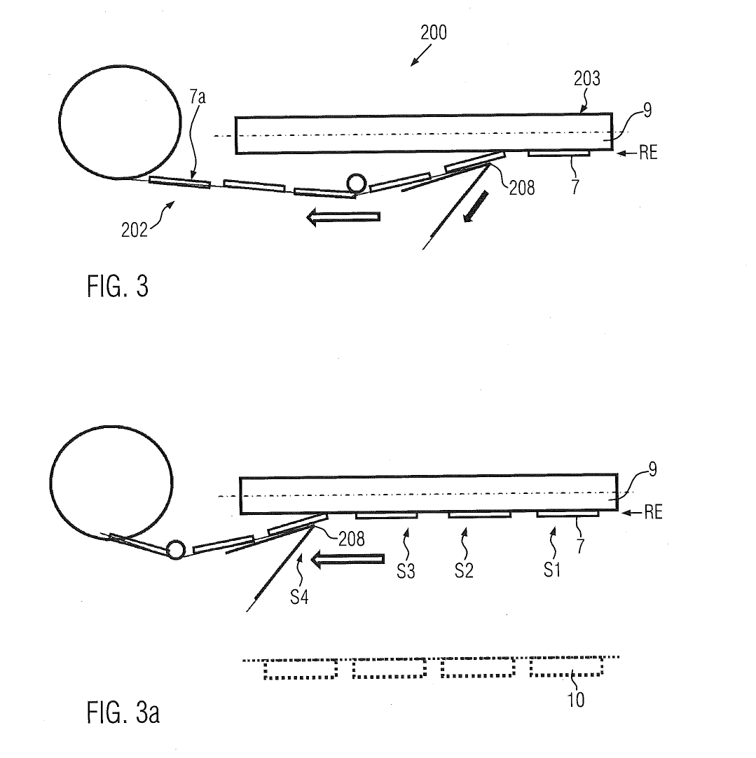

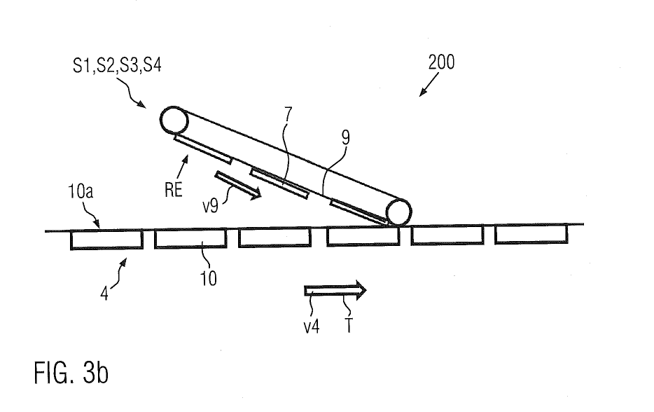

FIG. 3 shows schematically a further embodiment of the labeler 200 according to the present invention, comprising a transfer unit 203 and a dispenser 202 having a movable dispensing edge 208 for transferring a row RE of labels 7 to a label conveyor belt 9 of the transfer unit 203. Here, the labels 7 adhere with their non-adhesive upper surface 7a to the label conveyor belt 9. By moving the dispensing edge 208 to the left in the direction of the roll 5, with the label conveyor belt 9 being at rest, as shown in FIG. 3a, successive labels 7 can be transferred to the label conveyor belt 9 one by one. It is here also possible to establish a modified distance between two neighboring labels 7 in the direction of movement B. After transfer of a first row RE with four labels 7, the label conveyor belt 9 carries out an advance movement in the direction of the packages 10 so as to take up, subsequently, a second row RE of four labels 7. A group of labels 7 with several (e.g., three) rows RE and several (e.g., four) lanes S1 to S4 can be taken up in this way.

FIG. 3b shows, in a schematic side view, the label conveyor belt 9 with three rows RE of labels 7. Four lanes S1 to S4 of labels 7 are located therebehind, when seen in the drawing plane, so that twelve labels 7 are located on the lower surface of the label conveyor belt 9. When a movement of the package group 4 takes place, said package group 4 representing in a simplified form the film advance of a thermoform packaging machine, for example, downstream of the sealing station and upstream of the cutting station, the group of labels 7 will be applied to the upper surface 10a of the packages 10. The distances between two neighboring rows RE of labels 7 correspond preferably to the distance between two neighboring packages 10, when seen in the direction of transport T. The speeds v4 and v9 can thus be synchronized and it is guaranteed that the respective labels 7 will be applied precisely in position.

Other combinations with different numbers of rows RE and lanes S1 to S4 are imaginable. According to a further variant, which is, however, not shown, a plurality of dispensers 2 without a movable dispensing edge 208 for a respective lane S1 to S4 is imaginable.

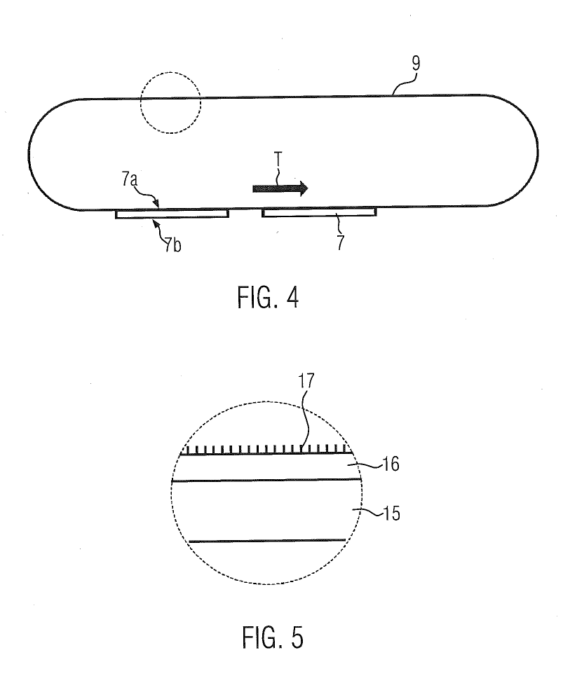

FIG. 4 shows a preferred embodiment of the endless label conveyor belt 9 conveying labels 7 in a direction of transport T. The adhesive surface 7b is here the lower surface of the label 7 and the non-adhesive surface 7a is the upper surface of the label 7.

In the enlarged representation of a cross-section of the label conveyor belt 9, shown in FIG. 5, a carrier layer 15 and a nano- or microstructured silicone coating 16, which is connected to said carrier layer 15, are schematically shown. The coating 16, which represents the surface of the label conveyor belt 9, is permanently applied, for example, by means of an adhesive or applied directly to the carrier material. Adhesion elements 17 may be provided so that the labels can be held with their non-adhesive sides on the basis of van der Waals forces, at least 15,000 of said adhesion elements 17 being provided per cm² in the label conveyor belt area that is intended to be used for conveying the labels.

The carrier layer 15 may be a fabric, for example, a textile fabric, or it may be configured as a multilayer material so as to guarantee the properties of a circulating belt and provide, in addition, an improved surface for applying the coating 16.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A labeler comprising:
a dispenser; and
a transfer unit having at least one label conveyor belt for applying a label to a product;
wherein the at least one label conveyor belt has an adhesive force so as to be able to take up labels with their non-adhesive upper surface on the surface of the label conveyor belt and convey them.

2. A labeler according to claim 1, wherein the adhesive force is based on Van der Waals forces.

3. A labeler according to claim 1, wherein a nano- or micro structured coating is provided as surface of the label conveyor belt.

4. A labeler according to claim 3, wherein the coating has a surface including more than 15,000 adhesion elements per cm².

5. A labeler according to claim 3, wherein the coating has a surface including more than 25,000 adhesion elements per cm².

6. A labeler according to claim 3, wherein the coating is a silicone coating.

7. A labeler according to claim 1, wherein the adhesive force is based on electrostatic forces between the label and the label conveyor belt.

8. A labeler according to claim 1, wherein the label conveyor belt is provided for taking up a row of labels.

9. A labeler according to claim 8, wherein the label conveyor belt is provided for synchronously transferring a row of labels to a package group.

10. A labeler according to claim 8, wherein a plurality of rows of labels can be transferred to the label conveyor belt so as to form a group of labels comprising a plurality of rows and a plurality of lanes.
